(19) United States
(12) Patent Application Publication
(10) Pub. No.: US 2005/0286259 A1
(43) Pub. Date: Dec. 29, 2005

(54) Mounting device for a light-emitting diode

(76) Inventor: Tiger Wang, Sanchung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/878,008

(22) Filed: Jun. 29, 2004

(51) Int. Cl. F21W 11/02

(52) U.S. Cl. 362/545

(57) ABSTRACT

A mounting device is used in a vehicle lamp and has at least one base, a circuit board and a reflective cover. The vehicle lamp further has a protective cover, at least one LED, a protective cover and an electrical connector. Each LED has two electrical leads. Each base has a longitudinal through hole, a distal end and a proximal end. An LED is mounted in the distal end of each base. The proximal end of each base is mounted on the circuit board. The circuit board has multiple connection holes with two connection holes corresponding to each base so the LED electrical leads can be connected to the circuit board respectively in the two connection holes. The reflective cover has at least one through hole corresponding respectively to the at least one base so the LED can pass through the reflective cover.

### BACKGROUND OF THE INVENTION

1. Field of the Invention

The present invention relates to a mounting device, and more particularly to a mounting device for a light-emitting diode in a vehicle lamp.

2. Description of the Prior Arts

Because light-emitting diodes (LEDs) have low temperature and low power consumption characteristics, LEDs have gained popularity and are rapidly replacing incandescent bulbs in lamps, electronic billboards, traffic lights and the like. When an LED is used in a vehicle lamp, a reflective cover is mounted around the LED and directs emitted light. The light passes through a protective cover to the outside. Then other people see the light to prevent vehicle accidents.

However, the LED has only a pair of connections to mount the LED on a circuit board. The normal vibration and shock of a moving vehicle easily breaks the LED connections and causes the LED to break and possibly dislodge from the circuit board.

To overcome the shortcomings, the present invention provides a mounting device for a light-emitting diode to mitigate or obviate the aforementioned problems.

### SUMMARY OF THE INVENTION

The main objective of the invention is to provide a mounting device for a light-emitting diode. The mounting device is used in a vehicle lamp. The mounting device includes a circuit board, at least one base and a reflective cover. Each base has a through hole to hold a light emitting diode (LED) and to prevent the LED from vibrating or being shocked when the vehicle is moving. The reflective cover has multiple through holes. The reflective cover reflects the light from the LEDs to make the light brighter. The mounting device as described is easy to assemble.

Other objectives, advantages and novel features of the invention will become more apparent from the following detailed description when taken in conjunction with the accompanying drawings.

### BRIEF DESCRIPTION OF THE DRAWINGS

FIG. 1 is a side view in partial section of a mounting device for a light-emitting diode in accordance with the present invention with light-emitting diodes and a protective cover;

FIG. 2 is a partially exploded side view in partial section of the mounting device in FIG. 1 with a light-emitting diode;

FIG. 3 is a side view in partial section of the mounting device in FIG. 2;

FIG. 4 is a partially exploded side view in partial section of the mounting device in FIG. 1 with a first embodiment of the reflective cover in accordance with the present invention with multiple LEDs and a protective cover;

FIG. 5 is a partially exploded perspective view of a second embodiment of a base and a circuit board in accordance with the present invention with a light-emitting diode;

FIG. 6 is a partially exploded side view in partial section of the base and circuit board in FIG. 5;

FIG. 7 is a perspective view of the base and circuit board in FIG. 5;

FIG. 8 is a side view in partial section of the of the base and circuit board in FIG. 6; and

FIG. 9 is an exploded side view in partial section of a second embodiment of a reflective cover in accordance with the present invention in the mounting device in FIG. 1 with multiple light-emitting diodes.

### DETAILED DESCRIPTION OF THE PREFERRED EMBODIMENTS

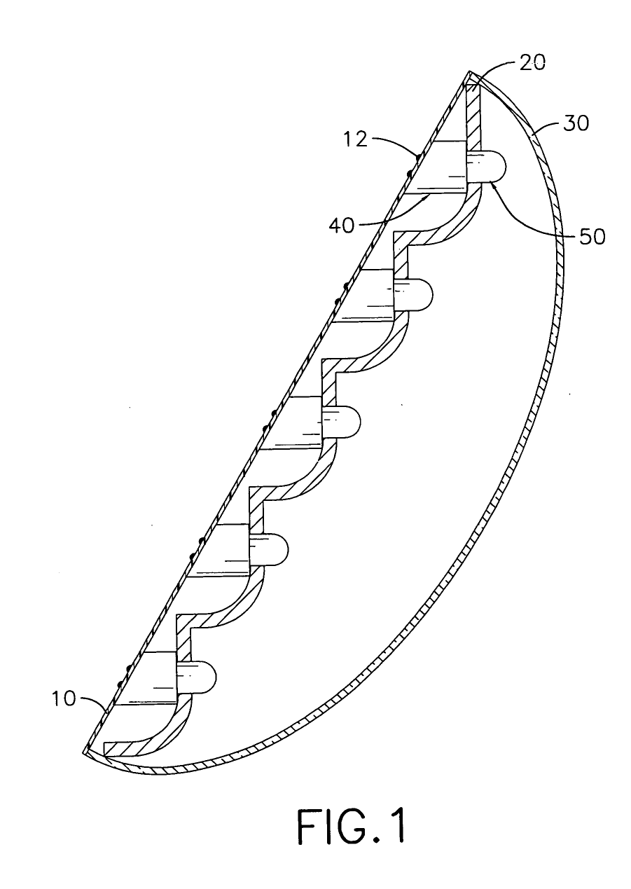

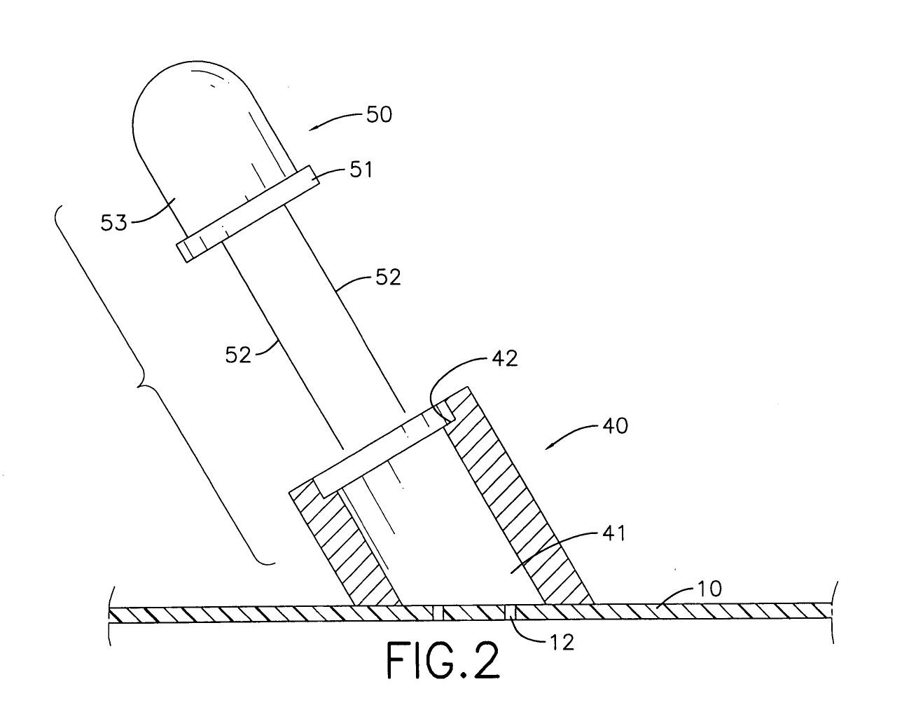

With reference to FIG. 1, the present invention is a mounting device for light-emitting diodes (LEDs) used in a vehicle lamp. The mounting device in accordance with present invention comprises at least one base (40), a circuit board (10) and a reflective cover (20). The vehicle lamp comprises the mounting device, at least one LED (50), a protective cover (30) and an electrical connector (not shown). With further reference to FIG. 2, each LED (50) has a body (53), a flange (51) and two electrical leads (52), is mounted in a base (40) and is connected electrically to the circuit board (10). The body (53) has a radius (not numbered), and the flange (51) has a radius (not numbered) that is larger than the radius of the body (53).

A first embodiment of the base (40) in accordance with the present invention has a proximal end, a distal end, a through hole (41) and an optional internal shoulder (42). The through hole (41) is formed longitudinally through the base (40). The internal shoulder (42) is formed in the through hole (41) at the distal end of the base (40). In a first embodiment of the mounting device in accordance with the present invention, the at least one base (40) is formed separately.

A first embodiment of the circuit board (10) in accordance with the present invention has two connection holes (12) for each base (40). The proximal end of each base (40) is attached to the circuit board (10) around two connection holes (12).

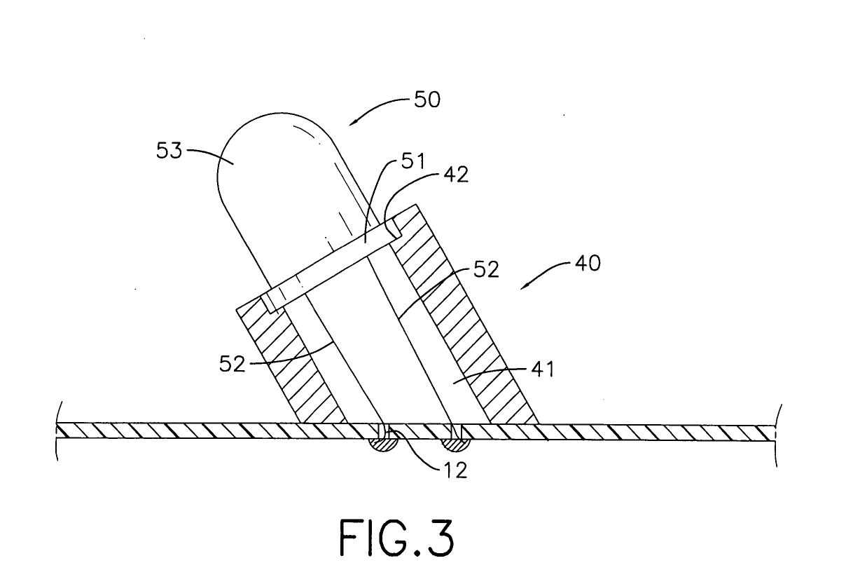

With further reference to FIG. 3, the at least one LED (50) is mounted respectively in the at least one base (40). The electrical leads (52) of each LED (50) pass through the through hole (41) in the base (40), respectively through the corresponding connection holes (12) and are connected respectively to the connection points (12) in the circuit board (10). The flange (51) around each LED (50) is mounted in the distal end of the base (40) and is seated on the optional internal shoulder (42).

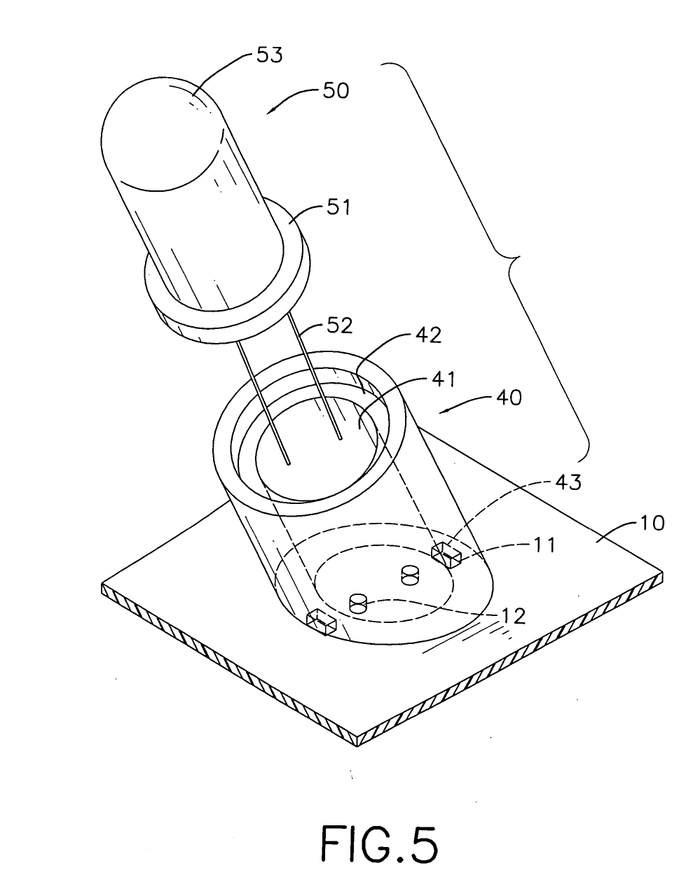

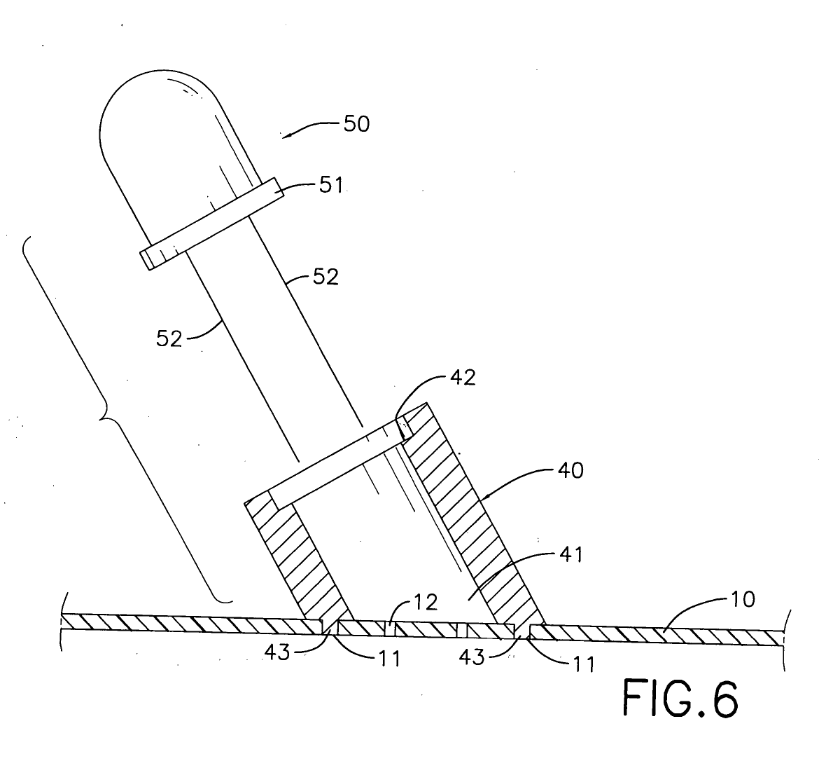

With reference to FIGS. 5 and 6, a second embodiment of the circuit board (10) in accordance with the present invention further comprises multiple mounting recesses (11). At least one mounting recess (11) corresponds to each one of the connection holes (12).

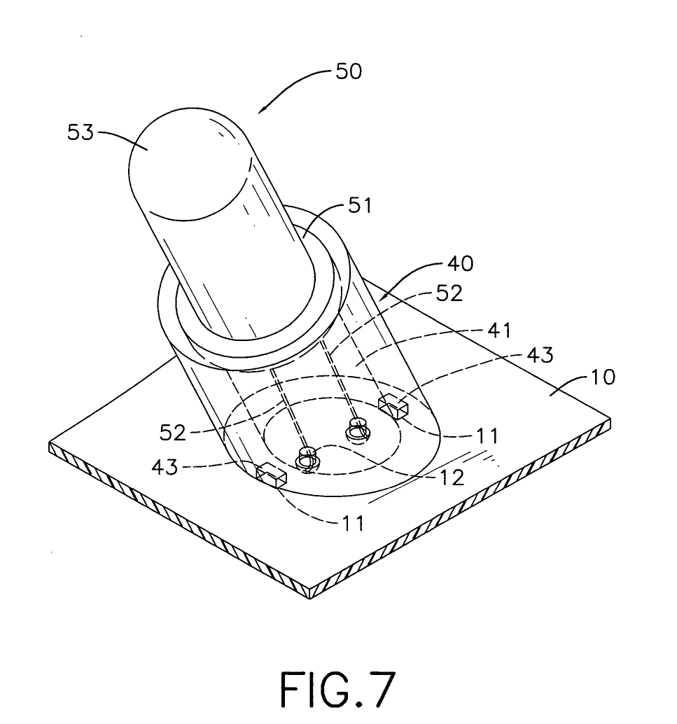

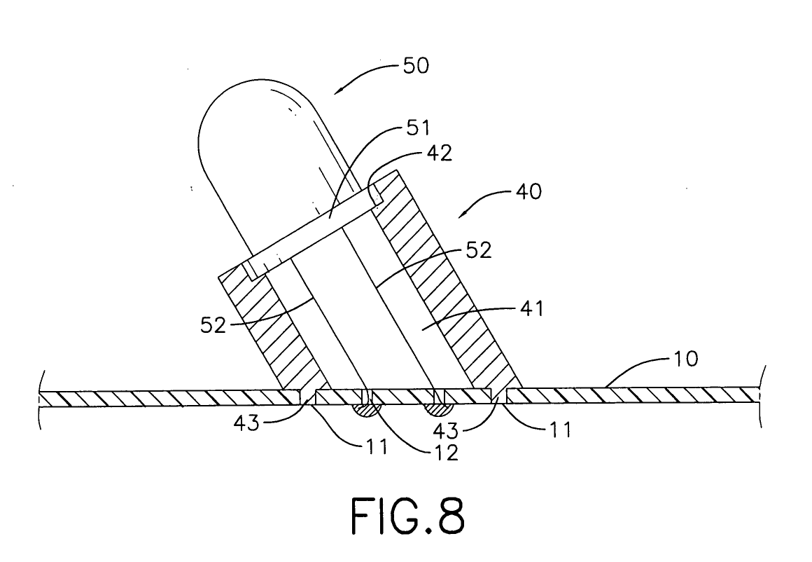

A second embodiment of each base (40) in accordance with the present invention further comprises multiple protrusions (43) corresponding respectively to the mounting recess (11) around the two connection holes (12). With further reference to FIGS. 7 and 8, the protrusions (43) are formed on and extend from the proximal ends of the bases (40) and are mounted respectively in the mounting recesses (11) in the circuit board (10).

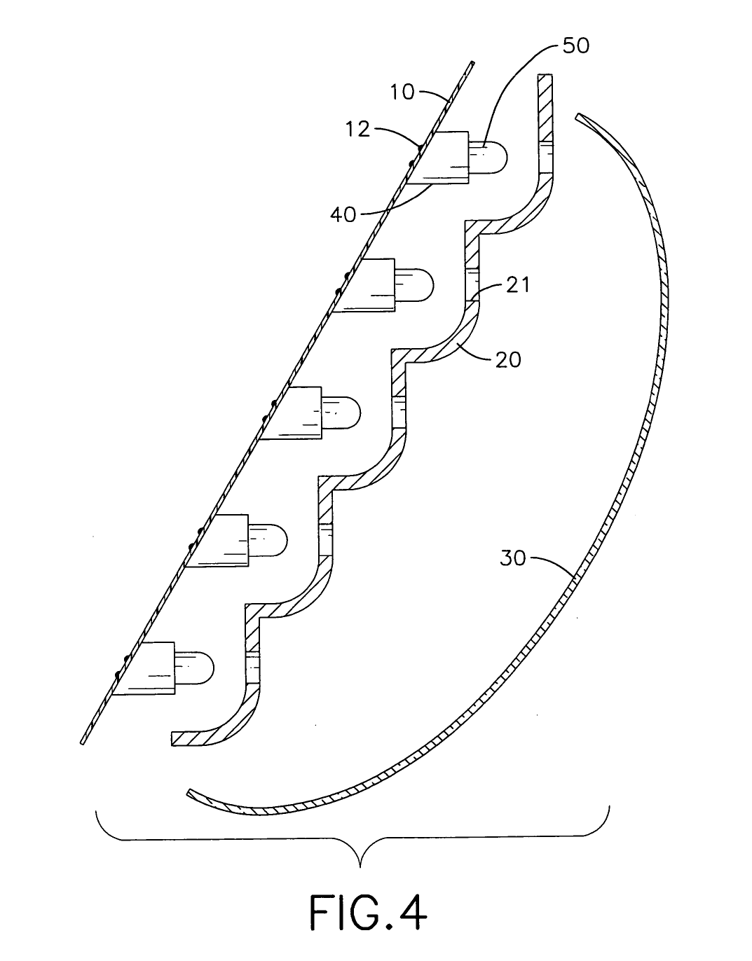

With further reference to FIG. 4, a first embodiment of the reflective cover (20) in accordance with the present invention has two ends, an inside surface, a reflective outside surface and multiple through holes (21). The through holes (21) have a radius, are formed through the reflective cover (20) and correspond respectively to the through holes (41) in the bases (40). The radii of the through holes (21) are the same as the radii of the bodies (53) of the LEDs (50).

The vehicle lamp is assembled by mounting the bases (40) on the circuit board (10), installing the LEDs (50), attaching the reflective cover (20), attaching the protective cover (30) and connecting the assembled element to an electrical connector. The flanges (51) of the LEDs (50) are mounted respectively in the distal ends of the bases (40), and the LEDs (50) pass respectively through the through holes (21) in the reflective cover (20) and protrude from the reflective surface. Then the protective cover (30) is attached to the mounting device to enclose the LEDs (50) and the reflective cover (20).

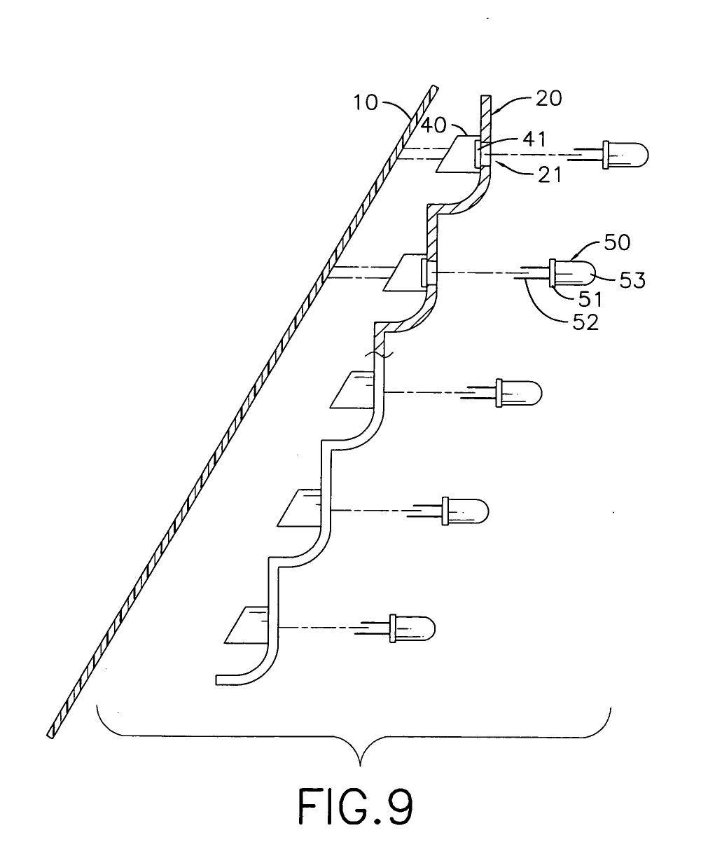

With reference to FIG. 9, a second embodiment of the reflective cover (20) in accordance with the present invention further has the base (40) formed integrally on the inside surface and the radius of the through holes (21) the same as the radius of the flanges (51) of the LEDs (50). The distal ends of the bases (40) are formed respectively around the through holes (21) in the reflective cover (20). The flanges (51) of the LEDs (50) pass respectively through the through holes (21) and are mounted in the distal ends of the bases (40). The protective cover (30) is mounted over the reflective cover (20) and is attached to the circuit board (10).

The mounting device for a light-emitting diode as described has a number of advantages. The bases (40) hold the LEDs (50) and significantly reduce the amount the LEDs (50) move independently from the circuit board (10) when subjected to shock and vibration. The reflective cover (20) reflects light from the LEDs (50) and makes the vehicle lamp brighter. Furthermore, the mounting device as described is easy to assemble.

Even though numerous characteristics and advantages together with details of the structure and function of the present invention have been set forth in the foregoing description, the disclosure is illustrative only. Changes may be made in detail, especially in matters of shape, size and arrangement of parts within the principles of the invention to the full extent indicated by the broad general meaning of the terms in which the appended claims are expressed.

1. A mounting device of a light-emitting diode used in a vehicle lamp having at least one light-emitting diode (LED) a protective cover and an electrical connector, and the mounting device having;
at least one base and each one of the at least one base having;
a proximal end;
a distal end; and
a through hole formed longitudinally through the base;
a circuit board having two connection holes for each one of the at least one base around which the proximal end of the base is attached to the circuit board;
a reflective cover attached to the circuit board and having;
two ends mounted on the circuit board;
an inside surface;
a reflective outside surface; and
multiple through holes having a radius, formed through the reflective cover corresponding to the at least one through hole in the at least one base.

2. The mounting device for a light-emitting diode as claimed in claim 1, wherein
each one of the at least one base has a internal shoulder formed in the through hole at the distal end of the base.

3. The mounting device for a light-emitting diode as claimed in claim 1, wherein the at least one base is formed separately from the reflective cover.

4. The mounting device for a light-emitting diode as claimed in claim 2, wherein the at least one base is formed separately from the reflective cover.

5. The mounting device for a light-emitting diode as claimed in claim 1, wherein the circuit board has at least one mounting recess and each one of the at least one mounting recess corresponds to one of the at least one base; and
each one of the at least one base has a protrusion formed on and extending from the proximal end of the base and mounting respectively in the corresponding mounting recess in the circuit board.

6. The mounting device for a light-emitting diode as claimed in claim 2, wherein the circuit board has at least one mounting recess and each one of the at least one mounting recess corresponds to one of the at least one base; and
each one of the at least one base has a protrusion formed on and extending from the proximal end of the base and mounting respectively in the corresponding mounting recess in the circuit board.

7. The mounting device for a light-emitting diode as claimed in claim 1, wherein
the distal end of the at least one base is formed on the inside surface of the reflective cover.

8. The mounting device for a light-emitting diode as claimed in claim 5, wherein
the distal end of the at least one base is formed on the inside surface of the reflective cover.
